(19) United States
(12) Patent Application Publication
(10) Pub. No.: US 2007/0016761 A1
(43) Pub. Date: Jan. 18, 2007

(54) Method, apparatus, and computer program product for implementing enhanced system behavior control

(75) Inventors: Jason Robert Almeida, Raleigh, NC (US); Steven C. Erickson, Rochester, MN (US); Fraser Allan Syme, Rochester, MN (US); Antoine George Sater, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: International Business Machines Corporation, Armonk, NY (US)

(21) Appl. No.: 11/171,721

(22) Filed: Jun. 30, 2005

(51) Int. Cl. G06F 15/177

(52) U.S. Cl. 713/1

(57) ABSTRACT

A method, apparatus and computer program product are provided for implementing enhanced system behavior control in a computer system. A system behavior control tool is attached to a computer system during power on or runtime. The attachment of the system behavior control tool causes predefined default behaviors to be overridden and changed based upon the detection of the attached system behavior control tool. At least one predefined setting from the attached system behavior control tool is applied to the computer system. At applying the least one predefined setting to the computer system, then the computer system is rebooted.

### FIELD OF THE INVENTION

The present invention relates generally to the data processing field, and more particularly, relates to a method, apparatus and computer program product for implementing enhanced system behavior control.

### DESCRIPTION OF THE RELATED ART

In a computer system, system firmware dictates system functionality. Enhancements or changes in the system firmware normally involve a new system firmware being written, tested and released, which typically is an intensive and time-consuming process.

Unique firmware capability is required during manufacturing to perform system debug and process/product automation. The time period for product development is becoming shorter with each computer system release. It has become a necessity to provide faster debug turnaround and customer system debug at location. Customer downtime caused by system failure requires faster and portable debug capability for faster turnaround.

U.S. Pat. No. 5,987,536 to Johnson et al., issued Nov. 16, 1999 and assigned to the present assignee discloses a personal computer system including a central processing unit (CPU) coupled to a direct access storage device (DASD) and a random access memory (RAM). A flash memory module is coupled to the CPU and an input/output (IO) bus and includes a basic input output system (BIOS) stored therein. The BIOS is effective for responding to the energization of the computer system by initiating a power on self test (POST). The BIOS is further operative on completion of the POST for transferring a portion of BIOS from the module to the RAM and for transferring control of the of the computer system to the BIOS portion. The portion of BIOS is operative to load a protected mode operating system (OS) into RAM and transfer control to the OS. The system further includes a logic circuit coupled to the flash memory module and the IO bus for allowing the BIOS in flash memory to be accessed while the protected mode OS is running. The advantage provided is that BIOS can now be accessed, e.g., read from, written to, updated, modified, etc., while a protected mode operating system is running without the need to reboot to a DOS operating system. This allows local BIOS updates via the system's DASD or remote BIOS updates over a network without affecting the end user.

U.S. Pat. No. 6,353,885 to Herzi et al., issued Mar. 5, 2002 discloses a computer system having capability for implementing BIOS level configuration settings includes at least one processor, at least one memory, basic input output system (BIOS) firmware, and at least one BIOS configurable device. The at least one memory includes operating system code. The BIOS firmware includes a smart card BIOS level setting support feature. The BIOS configurable device is subject to being configured by the at least one processor in response to a prescribed smart card actuation of the smart card BIOS level setting support feature prior to a booting of the operating system code.

A need exists for an effective mechanism to provide enhanced system firmware for implementing enhanced system behavior control. It is desirable to provide such mechanism to provide enhanced system firmware on the fly.

### SUMMARY OF THE INVENTION

Principal aspects of the present invention are to provide a method, apparatus and computer program product for implementing enhanced system behavior control. Other important aspects of the present invention are to provide such method, apparatus and computer program product for implementing enhanced system behavior control substantially without negative effect and that overcome many of the disadvantages of prior art arrangements.

In brief, a method, apparatus and computer program product are provided for implementing enhanced system behavior control in a computer system. A system behavior control tool is attached to a computer system during power on or runtime. The attachment of the system behavior control tool causes predefined default behaviors to be overridden and changed based upon the detection of the attached system behavior control tool. At least one predefined setting from the attached system behavior control tool is applied to the computer system. At applying the least one predefined setting to the computer system, then the computer system is rebooted.

In accordance with features of the invention, an external port is used for attachment of a system behavior control tool to the computer system that includes a selected one of a serial port, a parallel port, a USB port, and a floppy disk drive. The system behavior control tool is implemented by, for example, a hardware only device or a hardware device with stored software and data, such as settings and code images. Also the system behavior control tool can be implemented by a removable floppy disk where the external port is a floppy disk drive.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B is a schematic diagram of an exemplary computer system and operating system for implementing enhanced system behavior control in accordance with the preferred embodiment;

FIGS. 2, 3, and 4 are flow charts illustrating exemplary steps of methods for implementing enhanced system behavior control in accordance with the preferred embodiment;

FIG. 5 is a block diagram illustrating a computer program product in accordance with the preferred embodiment.

### DETAILED DESCRIPTION OF THE PREFERRED EMBODIMENTS

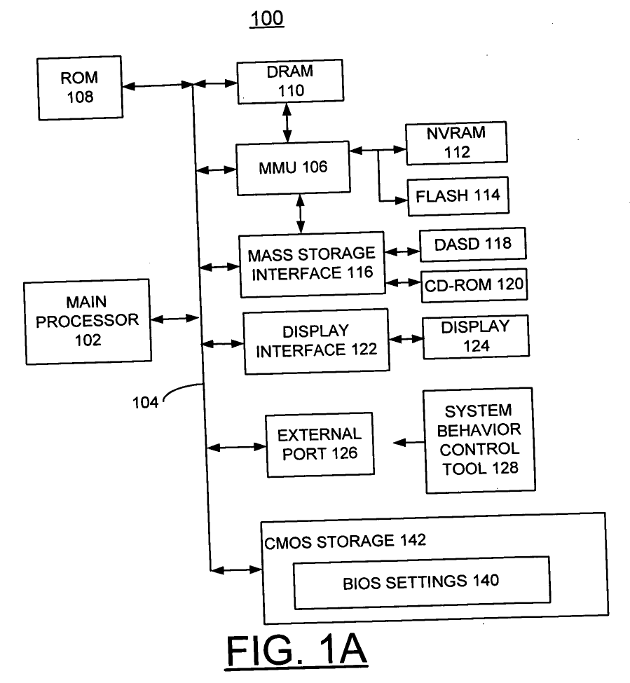

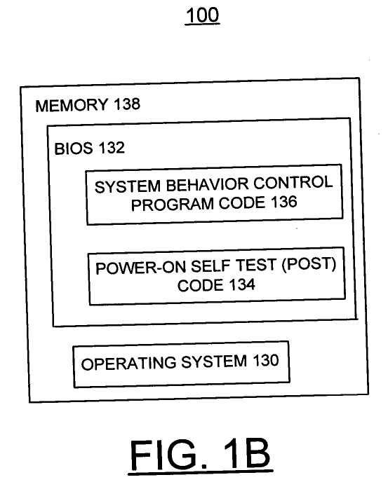

Having reference now to the drawings, in FIGS. 1A and 1B, there is shown an exemplary computer system generally designated by the reference character 100 for implementing methods for enhanced system behavior control in accordance with the preferred embodiment. Computer system 100 includes a main processor 102 or central processor unit (CPU) 102 coupled by a system bus 104 to a memory management unit (MMU) 106 and system memory including, a read only memory 108, a dynamic random access memory (DRAM) 110, a nonvolatile random access memory (NVRAM) 112, and a flash memory 114. A mass storage interface 116 coupled to the system bus 104 and MMU 106 connects a direct access storage device (DASD) 118 and a CD-ROM drive 120 to the main processor 102. Computer system 100 includes a display interface 122 connected to a display 124. Computer system 100 includes an external port 126 coupled to the system bus 104.

In accordance with features of the preferred embodiment, attachment of a system behavior control tool 128 to the computer system 100 is provided via the external port 126, such as a serial port, a parallel port, a USB port, a floppy disk drive and the like. The attachment of the system behavior control tool 128 causes predefined default behaviors to be overridden and changed based upon the detection of the attached system behavior control tool 128. The system behavior control tool 128 is implemented by, for example, a hardware only device or a hardware device with stored software and data, such as settings and code images. Also the system behavior control tool 128 can be implemented by a removable floppy disk where the external port 126 is a floppy disk drive.

Computer system 100 is shown in simplified form sufficient for understanding the present invention. The illustrated computer system 100 is not intended to imply architectural or functional limitations. The present invention can be used with various hardware implementations and systems and various other internal hardware devices, for example, instead of a single main processor 102, multiple main processors can be used.

As shown in FIG. 1B, computer system 100 includes an operating system 130, a Basic Input/Output System (BIOS) 132 including a Power-On Self Test program (POST) code 134 and a system behavior control program code 136 of the preferred embodiment resident in a memory 138.

In accordance with features of the preferred embodiment, as shown in FIG. 1A, computer system 100 includes a plurality of BIOS settings 140 stored in CMOS storage 142 that can be overridden and changed based upon the detection of the attached system behavior control tool 128. For example, changing selected BIOS settings 140 enables implementing enhanced system behavior control on the fly with the system behavior control tool 128 being inserted before, during or after POST during power on or during runtime of computer system 100.

For example, with the system behavior control tool 128 implemented on a floppy disk, and when a particular BIOS setting 140 disables the floppy drive, without changing this particular BIOS setting 140, the floppy disk system behavior control tool 128 could not be read, and the settings on the floppy disk system behavior control tool 128 could not be read. In accordance with of the preferred embodiment, a path to the floppy disk system behavior control tool 128 is available on every boot by changing and overriding this particular BIOS setting 140 in the CMOS storage 142. Then the desired or typical BIOS settings stored in the CMOS storage 142 are applied as the system reboots.

In accordance with features of the preferred embodiment, the system behavior control tool 128 can be used at the customer site to collect and debug a failure. For example, the system behavior control tool 128 can be detected on a USB port 126 by the system behavior control program code 136.

In accordance with features of the preferred embodiment, the system behavior control program code 136 causes BIOS settings 140 to be read from the system behavior control tool 128 and then updated in the selected BIOS settings stored in the CMOS storage 142. The system behavior control program code 136 can cause the downloading of a new BIOS and firmware image from the system behavior control tool 128 to replace the current BIOS 132 and firmware image of computer system 100 automatically.

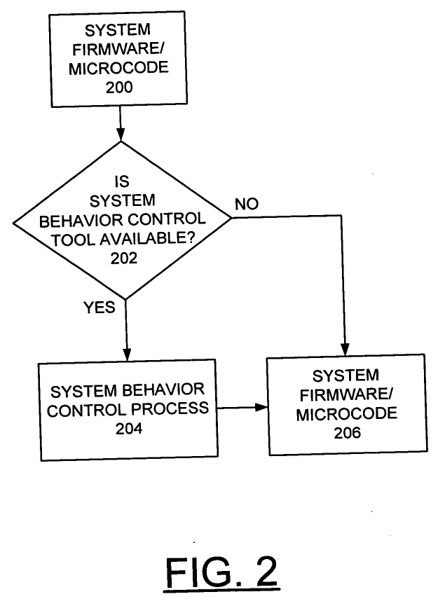

Various commercially available computers can be used for computer system 100, for example, an IBM personal computer or an RS/6000® server computer system manufactured and sold by International Business Machines Corporation of Armonk, N.Y. CPU 102 is suitably programmed by the system behavior control program code 136 to execute the flowcharts of FIGS. 2, 3, and 4 for implementing enhanced system behavior control in accordance with the preferred embodiment.

Referring now to FIG. 2, there are shown exemplary steps for implementing enhanced system behavior control in accordance with the preferred embodiment. As indicated in a block 200, operations begin with system firmware and microcode, such as BIOS 132. BIOS 132 including the system behavior control program code 136 of the preferred embodiment checks whether system behavior control tool 128 is available as indicated in a decision block 202. When the system behavior control tool 128 is available, then the system behavior control process is performed as indicated in a block 204. When the system behavior control tool 128 is not available and after the system behavior control process is performed, then operations continue with system firmware and microcode as indicated in a block 206.

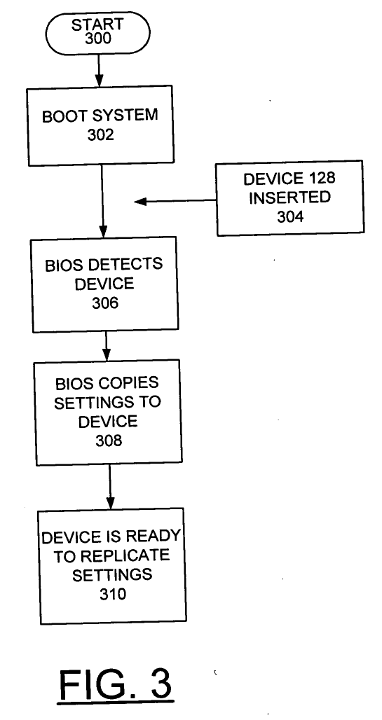

Referring now to FIG. 3, there are shown exemplary steps for implementing enhanced system behavior control for preparing a system behavior control tool 128 for replication in accordance with the preferred embodiment starting at a block 300. Computer system 100 boots as indicated in a block 302. A system behavior control tool 128 is inserted as indicated in a block 304. The BIOS 132 detects the system behavior control tool 128 as indicated in a block 306. Then the BIOS 132 copies settings to the system behavior control tool 128 as indicated in a block 308. As indicated in a block 310, the system behavior control tool 128 is ready to replicate settings.

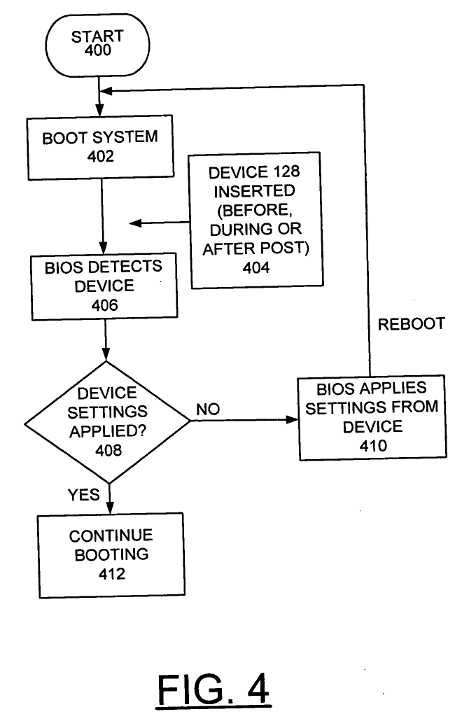

Referring now to FIG. 4, there are shown exemplary steps for implementing enhanced system behavior control for replicating settings using a system behavior control tool 128 in accordance with the preferred embodiment starting at a block 400. Computer system 100 boots as indicated in a block 402. A system behavior control tool 128 is inserted as indicated in a block 404. The BIOS 132 detects the system behavior control tool 128 as indicated in a block 406. Then checking whether the device settings have been applied to the computer system 100 is performed as indicated in a decision block 408.

When the device settings have not been applied to the computer system 100, then the BIOS 132 including the system behavior control program code 136 of the preferred embodiment applies the settings from the system behavior control tool 128 to the computer system 100 as indicated in a block 410.

After the settings from the system behavior control tool 128 are applied to the computer system 100, then the exemplary operations continue returning to block 402. A reboot is provided when transitioning from the state at block 410 to the state at block 402.

In accordance with features of the preferred embodiment, this reboot enables applying certain BIOS settings that otherwise cannot be applied with conventional BIOS control arrangements.

Otherwise, when determined at decision block 408 that the device settings have already been applied to the computer system 100, then the BIOS 132 continues booting as indicated in a block 412.

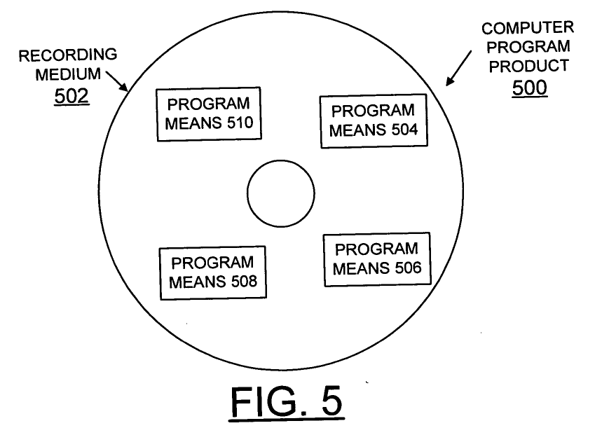

Referring now to FIG. 5, an article of manufacture or a computer program product 500 of the invention is illustrated. The computer program product 500 includes a recording medium 502, such as, a floppy disk, a high capacity read only memory in the form of an optically read compact disk or CD-ROM, a tape, a transmission type media such as a digital or analog communications link, or a similar computer program product. Recording medium 502 stores program means 504, 506, 508, 510 on the medium 502 for carrying out the methods for implementing enhanced system behavior control of the preferred embodiment in the system 100 of FIGS. 1A and 1B.

A sequence of program instructions or a logical assembly of one or more interrelated modules defined by the recorded program means 504, 506, 508, 510, direct the computer system 100 for implementing enhanced system behavior control of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A method for implementing enhanced system behavior control in a computer system comprising:
detecting an attached system behavior control tool to the computer system during power on or runtime;
overriding and changing predefined default behaviors based upon the detection of the attached system behavior control tool;
applying at least one predefined setting from the attached system behavior control tool to the computer system; and
responsive to applying the least one predefined setting to the computer system, rebooting computer system.

2. A method for implementing enhanced system behavior control as recited in claim 1 further comprising downloading a new Basic Input/Output System (BIOS) and firmware image from the attached system behavior control tool to the computer system.

3. A method for implementing enhanced system behavior control as recited in claim 1 wherein detecting an attached system behavior control tool comprises providing system behavior control program code with a Basic Input/Output System (BIOS) of the computer system.

4. A method for implementing enhanced system behavior control as recited in claim 1 wherein detecting an attached system behavior control tool comprises detecting a system behavior control tool attached to an external port of the computer system, said external port includes a selected one of a serial port, a parallel port, a USB port, and a floppy disk drive.

5. A method for implementing enhanced system behavior control as recited in claim 1 wherein applying at least one predefined setting comprises overriding at least one predefined setting stored in CMOS storage of the computer system.

6. A method for implementing enhanced system behavior control as recited in claim 1 further comprising implementing said system behavior control tool by a hardware only device or a hardware device with stored software and data.

7. A method for implementing enhanced system behavior control in a computer system, comprising configuring a computer system to perform the method of claim 1.

8. Apparatus for implementing enhanced system behavior control in a computer system comprising:
a Basic Input/Output System (BIOS) including system behavior control program code for detecting an attached system behavior control tool to the computer system during power on or runtime;
said system behavior control program code for overriding and changing predefined default behaviors based upon the detection of the attached system behavior control tool;
said BIOS for applying at least one predefined setting from the attached system behavior control tool to the computer system; and
responsive to applying the least one predefined setting to the computer system, for rebooting computer system.

9. Apparatus for implementing enhanced system behavior control as recited in claim 8 wherein said BIOS overrides at least one predefined setting stored in CMOS storage of the computer system.

10. Apparatus for implementing enhanced system behavior control as recited in claim 8 wherein said system behavior control tool is attached to an external port of the computer system, said external port includes a selected one of a serial port, a parallel port, a USB port, and a floppy disk drive.

11. Apparatus for implementing enhanced system behavior control as recited in claim 8 wherein said system behavior control tool is implemented by a hardware only device or a hardware device with stored software and data.

12. Apparatus for implementing enhanced system behavior control as recited in claim 8 wherein said system behavior control tool is implemented by a removable floppy disk.

13. Apparatus for implementing enhanced system behavior control as recited in claim 8 wherein said system behavior control tool stores a new Basic Input/Output System (BIOS) and firmware image for downloading from the attached system behavior control tool to the computer system.

14. A computer program product for implementing enhanced system behavior control in a computer system, said computer program product including instructions executed by the computer system to cause the computer system to perform:
detecting an attached system behavior control tool to the computer system during power on or runtime;
overriding and changing predefined default behaviors based upon the detection of the attached system behavior control tool;
applying at least one predefined setting from the attached system behavior control tool to the computer system; and
responsive to applying the least one predefined setting to the computer system, rebooting computer system.

15. A computer program product for implementing enhanced system behavior control as recited in claim 14 further comprising downloading a new Basic Input/Output System (BIOS) and firmware image from the attached system behavior control tool to the computer system.

16. A computer program product for implementing enhanced system behavior control as recited in claim 14 wherein detecting an attached system behavior control tool comprises providing system behavior control program code with a Basic Input/Output System (BIOS) of the computer system.

17. A computer program product for implementing enhanced system behavior control as recited in claim 14 wherein detecting an attached system behavior control tool comprises detecting a system behavior control tool attached to an external port of the computer system, said external port includes a selected one of a serial port, a parallel port, a USB port, and a floppy disk drive.

18. A computer program product for implementing enhanced system behavior control as recited in claim 14 wherein applying at least one predefined setting comprises overriding at least one predefined setting stored in CMOS storage of the computer system.

19. A computer program product for implementing enhanced system behavior control as recited in claim 14 further comprising implementing said system behavior control tool by a hardware only device or a hardware device with stored software and data.

20. A computer program product for implementing enhanced system behavior control as recited in claim 14 further comprising implementing said system behavior control tool by a removable floppy disk.
